(19) United States
(12) Patent Application Publication
(10) Pub. No.: US 2008/0117230 A1
(43) Pub. Date: May 22, 2008

(54) Hanging Protocol Display System and Method

(76) Inventors: Rainer Wegenkittl, Sankt Poelten (AT); Donald K. Dennison, Waterloo (CA); John J. Potwarka, Waterloo (CA); Lukas Mroz, Wien (AT); Armin Kanitsar, Wien (AT); Gunter Zeilinger, Wien (AT)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/562,578

(22) Filed: Nov. 22, 2006

(51) Int. Cl. G09G 5/14; G06K 9/00

(52) U.S. Cl. 345/619; 382/128

(57) ABSTRACT

An image display system and method for presenting medical images according to a hanging protocol. Each hanging protocol contains one or more presentation groups Each presentation group defines a screen layout for a group of images and a set of interface display rules. A user may navigate through the presentation groups in a hanging protocol or may define a new presentation group. When a presentation group is loaded, interface elements are added and removed from the display according to the interface display rules.

### FIELD

The embodiments described herein relate to an image display systems and methods and more particularly to a system and method for defining a user interface using hanging protocols.

### BACKGROUND

Commercially available image display systems in the medical field utilize various techniques to present image views to a medical practitioner. Specifically, the image views produced within modalities such as Computed Radiograph (CR), Magnetic Resonance Imaging (MRI) and the like are displayed on a display terminal for review by a medical practitioner at a medical treatment site. These image views are used by the medical practitioner to determine the presence or absence of a disease, tissue damage etc. Many attempts have been made to optimize the presentation of such image views to the medical practitioner in order to improve review quality and speed.

Medical image views (i.e. views taken at different orientations within the patient) have been traditionally presented to a medical practitioner through the use of a hanging protocol. A hanging protocol is a display protocol that medical practitioners use to display different medical image views in a preferred sequence or order. Use of a hanging protocol allows the medical professional to review and study medical image views for a patient in a particular predictable sequence or order of interest. This allows the medical practitioner to more efficiently analyze medical image views for a large number of patients.

As shown in FIG. 1, in cases where physical films are still used, a technician clips such X-ray films 2 showing different image views for a patient onto a film alternator belt 3 according to a preferred viewing sequence or hanging protocol. The medical practitioner then has the technician run the film alternator belt 3 to display the various X-ray films 2 for a patient so that the views are displayed in a familiar sequence (i.e. according to a hanging protocol). The medical practitioner then reviews the various X-ray films 2 for the particular patient. In the example shown in FIG. 1, two image studies are being compared view by view (i.e. the axial view of Current Study A is compared to the axial view of Prior Study B, etc.) for patient A. This particular arrangement allows the medical professional to compare and contrast the current views with prior views on a view-by-view basis. This process is repeated for each patient to be examined that day. It has been observed by medical practitioners that by regulating the order in which medical image views are presented for a particular diagnostic review, it is possible to achieve effective and efficient review.

Since the advent of digitized image views, attempts have been made to incorporate the traditional hanging protocol concept into computerized medical image display systems. Today, computerized medical image review systems provide a medical practitioner with the ability to display a particular set of images in a particular sequence or order on a display screen or interface and across multiple display screens or interfaces. These capabilities are still referred to as hanging protocols.

A computerized medical image review system will often be sold with a set of default hanging protocols and/or the user may be able to design his or her own hanging protocol. Each hanging protocol in a computerized medical image review system normally consists of a set of presentation groups. A presentation group describes the way in which the data will be presented to the user including the layout of these images on the screen or interface. By proceeding through these presentation groups, a medical professional may follow the typical workflow for the specific set of data.

Besides the layout and presentation of the medical images themselves, it is also be useful to control which interface elements (e.g. scrollbars, buttons, menus, textboxes) are displayed with the medical image(s) based on the type of data being presented. Currently, the user does not have the ability to associate interface elements with a presentation group such that the presentation group controls which interface elements are displayed along with the medical image data.

### SUMMARY

The embodiments described herein provide in one aspect, a method for displaying at least one image on a display interface according to a first presentation group of a hanging protocol, wherein the method comprises:

(a) defining a first set of interface display rules for the first presentation group;

(b) evaluating the first set of interface display rules;

(c) displaying the at least one image according to the first presentation group;

(d) determining a first set of interface elements based on the application of the first set of interface display rules; and

(e) displaying the first set of interface elements in association with the display of the at least one image.

The embodiments described herein provide in another aspect, a system for displaying at least one image on a display interface according to a first presentation group of a hanging protocol, wherein the system comprises:

(a) a memory for storing the at least one image, the first presentation group and the hanging protocol;

(b) a processor coupled to the memory configured for:
(I) defining a first set of interface display rules for the first presentation group;
(II) evaluating the first set of interface display rules;
(III) displaying the at least one image according to the first presentation group;
(IV) determining a first set of interface elements based on the application of the first set of interface display rules; and
(V) displaying the first set of interface elements in association with the display of the at least one image.

Further aspects and advantages of the invention will appear from the following description taken together with the accompanying drawings.

### BRIEF DESCRIPTION OF THE DRAWINGS

For a better understanding of the embodiments described herein, and to show more clearly how it may be carried into effect, reference will now be made, by way of example, to the accompanying drawings which show at least one exemplary embodiment, and in which:

FIG. 1 is a schematic diagram illustrating a traditional method for displaying medical images to a medical practitioner according to a hanging protocol;

FIG. 2 is a block diagram of an exemplary embodiment of an image display system that defines a user interface using hanging protocols;

FIG. 3 is a flowchart diagram illustrating the basic operational steps of the image display system of FIG. 2;

FIG. 4 is a flowchart diagram illustrating the basic operational steps involved in selecting a hanging protocol;

FIG. 5 is a schematic diagram illustrating a screenshot of an image displayed according to a first presentation group;

FIG. 6 is a flowchart diagram illustrating the basic operation steps involved in defining a new presentation group; and

FIGS. 7A to 7C are schematic diagrams illustrating screenshots of an image series displayed according to a second presentation group.

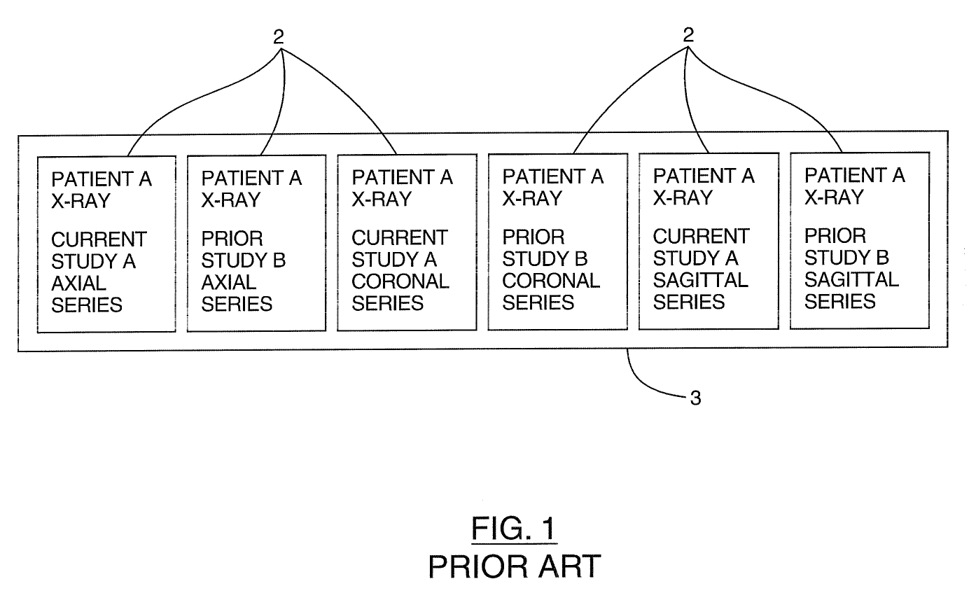

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, and cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

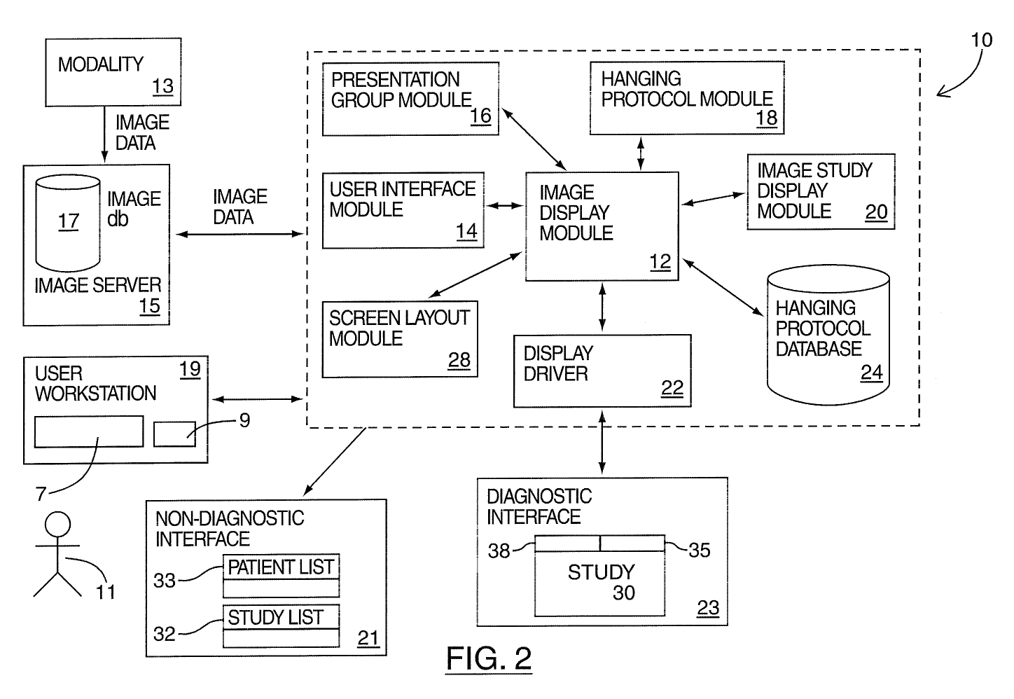

Reference is first made to FIG. 2, which illustrates the basic elements of an exemplary embodiment of an image display system 10. Image display system 10 includes an image display module 12, a user interface module 14, a presentation group module 16, a hanging protocol module 18, an image study display module 20, a display driver 22, and a hanging protocol database 24. Display entities (i.e. medical exams in the form of studies, series, or images) are generated by a modality 13 and stored in an image database 17. An index of patients is provided by a patient list 33 and an index of image studies 30 for a selected patient is provided by an image study list 32 both on non-diagnostic interface 21. Image display system 10 provides image data associated with image studies 30 through display driver 22 to any supported number of diagnostic interfaces, for example diagnostic interface 23, in response to commands issued by a medical practitioner user 11 through user workstation 19.

As discussed in more detail above, it should be understood that image display system 10 may be implemented in hardware or software or a combination of both. Specifically, the modules of image display system 10 are preferably implemented in computer programs executing on programmable computers each comprising at least one processor, a data storage system and at least one input and at least one output device. Without limitation the programmable computers may be a mainframe computer, server, personal computer, laptop, personal data assistant or cellular telephone. In some embodiments, image display system 10 is implemented in software and installed on the hard drive of user workstation 19 and on image server 15, such that user workstation 19 interoperates with image server 15 in a client-server configuration. In other embodiments, the image display system 10 can run from a single dedicated workstation that may be associated directly with a particular modality 13. In yet other embodiments, the image display system 10 can be configured to run remotely on the user workstation 19 while communication with the image server 15 occurs via a wide area network (WAN), such as through the Internet.

User workstation 19 includes a keyboard 7 and a user-pointing device 9 (e.g. mouse). It should be understood that user workstation 19 can be implemented by any wired or wireless personal computing device with input and interface means (e.g. conventional personal computer, laptop computing device, personal digital assistant (PDA), etc.) User workstation 19 is operatively connected to non-diagnostic interface 21, and diagnostic interface 23. Image display system 10 is used to provide image display formatting depending on user inputs through user workstation 19 and user pointing device 9. As discussed above, in certain exemplary embodiments, the image display system 10 is installed either on the hard drive of user workstation 19 and/or on image server 15 and preferably such that user workstation 19 works with image server 15 in a client-server configuration.

It should be understood that non-diagnostic interface 21 and diagnostic interface 23 are preferably controlled and linked to the same processing platform. This processing platform must provide high speed processing and support at least two video cards (i.e. a regular video card to support non-diagnostic interface 21 and a high performance video graphics card to support diagnostic interface 23).

Non-diagnostic interface 21 is optimized for image study 30 selection and provides a user 11 with a patient list 33 and an image study list 32. Patient list 33 provides a textual format listing of patients for which image studies 30 are available for interface. Image study list 32 provides a textual format listing of interface entities (e.g. image studies 30) that are available for display for the selected patient. Image study list 32 also includes associated identifying indicia (e.g. body part, modality, etc.) and organizes image studies 30 in current and prior study categories. Other associated textual information (e.g. patient information, image resolution quality, date of image capture, etc.) is simultaneously displayed within image study list 32 to assist the user 11 in selection of image studies 30 for a particular patient. Typically, user 11 will review image study list 32 and select listed image studies 30 from the study list 32.

Non-diagnostic interface 21 is preferably provided using a conventional color computer monitor display (e.g. a color monitor with a resolution of 1024×768). As discussed above, high resolution graphics are not necessary for non-diagnostic interface 21 since this interface is only displaying textual information to user 11.

When user 11 selects an image study 30, the selected image study 30 is displayed on diagnostic interface 23, according to a presentation group of a hanging protocol as will be discussed in further detail. Diagnostic interface 23 includes a hanging protocol menu 38 to present of list of available hanging protocols to the user 11 and a presentation group menu 35 to present a list of available presentation groups for the selected hanging protocol.

Diagnostic interface 23 provides high resolution image display of display entities (e.g. image studies 30) to user 11. The image studies 30 displayed on diagnostic interface 23 are typically a current image study 30 (i.e. image data from “today's” exam). Diagnostic interface 23 is preferably provided using a medical imaging quality monitor display with a relatively high resolution typically used for viewing CT and MR studies (e.g. black and white “reading” monitors with a resolution of 1280-1024 and up). While image display system 10 will mainly be discussed in respect of one diagnostic interface 23, it should be understood that image display system 10 can be adapted to display image studies 30 on any supported number of diagnostic interfaces.

Display driver 22 is a conventional display screen driver implemented using commercially available hardware and software. Display driver 22 ensures that display entities are displayed in a proper format on diagnostic interface 23.

Modality 13 is any conventional image data generating device (e.g. X-RAY equipment, Computed Tomography (CT) scanners, etc.) utilized to generate image data that corresponds to patient medical exams. A medical practitioner utilizes the image data generated by modality 13 to make a medical diagnosis (e.g. for investigating the presence or absence of a diseased part or an injury or for ascertaining the characteristics of the diseased part or the injury). Modalities 13 may be positioned in a single location or facility, such as a medical facility, or may be remote from one another. Image data from modality 13 is stored within image database 17 on image server 15 as conventionally known.

Image display module 12 coordinates the activities of user interface module 14, presentation group module 16, hanging protocol module 18, screen layout module 28 and image study display module 20 in response to commands sent by user 11 from user workstation 19.

When the user 11 first logs into the user workstation 19, a default user interface will be displayed on diagnostic interface 23 using user interface module 14. The default user interface may depend on the user workstation 19, the diagnostic interface 23, the user 11 or a combination of these.

Image display system 10 allows user 11 to select an image study 30 from image study list 32 for display on diagnostic interface 23. Once an image study 30 has been selected for display by user 11, hanging protocol module 18 will determine which hanging protocol of the hanging protocols stored in hanging protocol database 24 is best matched based on various factors including but not limited to, the image study 30 chosen (e.g. protocol code, modality, anatomic region), the user 11, the user workstation 19, the diagnostic interface 23 (e.g. monitor resolution, monitor color depth) and various other relevant factors, alone or in combination. Hanging protocol menu 38 is populated with this best matched hanging protocol followed by the next best matches as determined by the hanging protocol module 18. Image study 30 will initially be loaded using the best matched hanging protocol as determined by hanging protocol module 18 but user 11 may select a different hanging protocol from hanging protocol menu 38 if desired.

For the purposes of this discussion, a hanging protocol will be considered to include a collection of presentation groups which each provide a screen layout and a set of interface display rules for the display of an image study(ies) 30. The interface display rules define a list of interface elements to added to the default user interface and a list of interface elements to be removed from the default user interface. Once a hanging protocol has been selected, either by hanging protocol module 18 or by user 11 using hanging protocol menu 38, presentation group module 16 will populate presentation group menu 35 with a list of all the presentation groups defined by the selected hanging protocol in a pre-determined order.

The selected image study 30 will initially be presented according to a default presentation group as defined by the hanging protocol but user 11 may select a different presentation group from presentation group menu 35 if desired. Image display module 12 will display the selected image study 30 according to the screen layout defined by the selected presentation group using screen layout module 28. Interface elements will be added and removed from the default user interface according to the interface display rules for the selected presentation group using user interface module 14. In an exemplary embodiment, the presentation group menu 35 includes navigation buttons which allow user 11 to navigate through the available presentation groups one at a time.

Image study display module 20 is utilized by image display module 12 to retrieve image data from image server 15 associated with a selected image study 30 for display on diagnostic interface 23. When user 11 selects a patient from patient list 33 and then launches associated image study(ies) 30 from image study list 32 on non-diagnostic interface 21, image study display module 20 retrieves image data from image database 17 that corresponds to the selected image study(ies) 30 and provides it to image display module 12. Once the hanging protocol and presentation group have been determined, image display module 12 in turn applies the screen layout associated with the active presentation group to the selected image study 30. Image study display module 20 then instructs display driver 22 to display the suitably formatted selected image study(ies) 30 on diagnostic interface 23.

Presentation group module 16 also allows user 11 to define new presentation groups for a specific hanging protocol, using user workstation 19, to be stored in hanging protocol database 24 for future application.

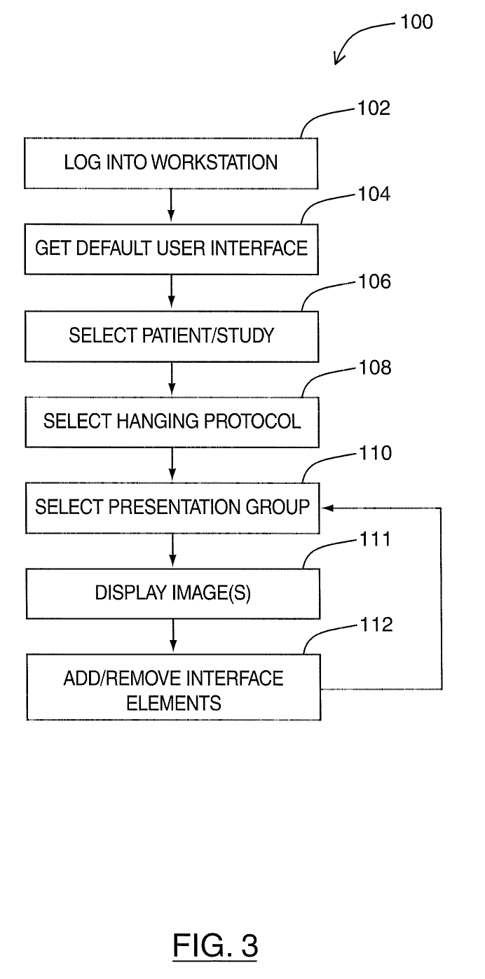

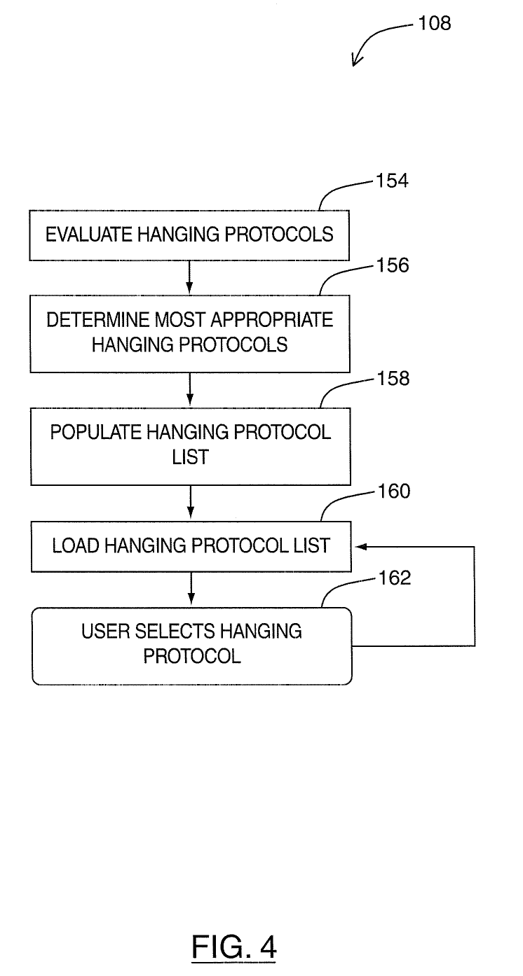

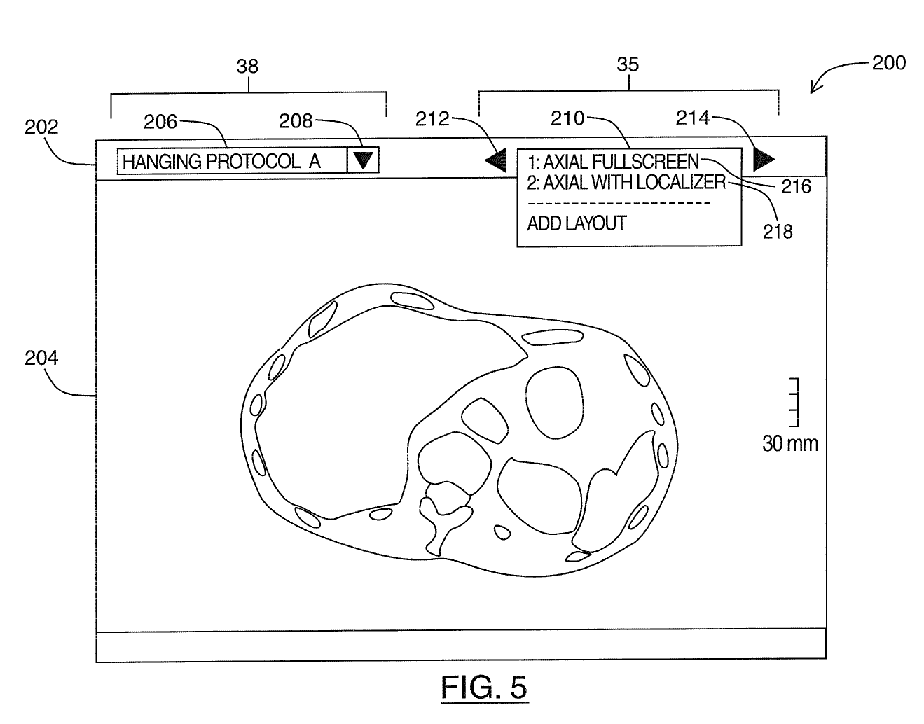

Reference is now made to FIGS. 2, 3, 4, and 5. Specifically, FIG. 3 is a flowchart diagram illustrating the general operational steps 100 executed by image display system 10. FIG. 4 is a flowchart diagram illustrating in more detail the operational step 108 of selecting a hanging protocol as performed by the hanging protocol module 18. FIG. 5 is a schematic diagram that illustrates a simplified user interface that may be used by a user 11 to interact with and instruct image display system 10. As will be understood, certain parts of the operational steps 100 can be performed by the user 11 through the user workstation 19 while other parts will be performed automatically by the image display system 10.

The user interface presented to user 11 on diagnostic interface 23 may include various interface elements such as scrollbars, buttons, menus, textboxes and the like. Each presentation group will include a set of interface display rules for controlling the interface elements presented when the presentation group is applied. When the user 11 first logs into workstation 19, a default user interface will be displayed on diagnostic interface 23. The interface display rules of each presentation group include a list of interface elements to be added to the default user interface and a list of interface elements to be removed from the default user interface, as appropriate.

Referring now to FIG. 3, at step (102), the user 11 logs into user workstation 19. At step (104), the user interface module 14 determines a default user interface and loads it. The default user interface may depend on various factors including without limitation, the type of workstation 19 (e.g., PDA, tablet personal computer), the class of workstation 19 (e.g. diagnostic viewing, clinical viewing), the diagnostic interfaces 23 (e.g. resolution, color support), the user 11, or various other factors, alone or in combination.

For example, the default user interface may depend on the number of display monitors that are used. A typical diagnostic system uses three monitors: one low-resolution color monitor to display textual image study information and two high-resolution (grayscale) monitors to display images. With this type of system, the user interface can be displayed across the two high-resolution monitors, allowing more room for interface elements. However, it has been found that simply displaying a user interface across two monitors is not efficient. In such cases, a special user interface is needed which replicates the most common interface elements on every monitor for fast access and groups the seldom used interface elements within the remaining space. Consequently, the default user interface for a three-monitor system may be quite different from the default user interface for a one-monitor system.

Another type of hardware-related consideration which may influence the default user interface is the input device used by workstation 19. For example, keyboard 7 may be a standard keyboard or it may be a special keyboard used only for certain types of medical practice, such as mammography reading. More interface elements may be needed with a standard device than with a special keyboard as these special keyboards often include extra functionality such as special keys/input elements. The interface elements corresponding to the special keys/input elements will not need to be displayed when the special keyboard is used.

In terms of user dependencies, some users may prefer that the whole screen space of the diagnostic interface 23 be available for images with no user interface. Other users may prefer a user interface which is similar to what they use on their personal computer. Other users would like the user interface of the workstation to be similar to the user interface of the modality workstation. These user preferences may also be taken into account when the default user interface is determined at step (104).

At step (106), user 11 selects a patient from patient list 33 and an image study from image study list 32. The data from the selected image study is retrieved from image database 17. Image display module 10 then determines how this image study is to be displayed on diagnostic interface 23.

At step (108), the hanging protocol is selected. As shown in more detail in FIG. 4, at step (154), hanging protocol module 18 evaluates the available hanging protocols stored in hanging protocol database 24 for suitability. Each hanging protocol includes information regarding the situations in which it should be applied. This may include information about the type of user 11, workstation 19, diagnostic interface 23, image study 30, etc. for which the particular hanging protocol is most appropriate. During the evaluation, hanging protocol module 18 will assign a score to each of the available hanging protocols based on how well it fits the current situation.

At step (156), hanging protocol module 18 determines which hanging protocols have the highest scores. It uses this information to populate hanging protocol list 206 (FIG. 5), at step (158), with the most appropriate hanging protocols sorted from highest score to lowest score.

At step (160), the most appropriate hanging protocol (i.e. the hanging protocol with the highest score) is loaded. The list of hanging protocols 206, discussed at step (158), allows user 11 to manually override the chosen hanging protocol. As shown in the example in FIG. 5, Hanging Protocol A has been selected and displayed in hanging protocol menu 38. Expand button 208 allows the user to expand the hanging protocol list 206 to view the list of appropriate hanging protocols, sorted by score, and (optionally) select an alternate hanging protocol at step (162). Referring back to FIG. 4, the user-selected hanging protocol is loaded at step (160).

Each hanging protocol has one or more associated presentation group. Each presentation group is numbered, preferably consecutively, starting at number one. Once the hanging protocol has been selected, the first presentation group of the selected hanging protocol will be loaded at step (110) and presentation group list 210 of presentation group menu 35 will be populated with all the presentation groups defined by the selected hanging protocol. The image(s) will then be displayed according to the screen layout associated with the first presentation group at step (111). Each presentation group contains a set of interface display rules which include a list of interface elements to be added to the user interface and a list of interface elements to be removed from the user interface. These interface elements will be added/removed from the user interface at step (112). It should be noted that steps (111) and (112) may occur in any order and, in many cases, step (111) will follow step (112).

The user 11 may then navigate through the presentation groups as desired. As shown in FIG. 5, in one exemplary embodiment, this navigation may be accomplished using presentation group menu 35 by selecting a presentation group 216, 218 from the list of presentation groups in presentation group list 210 or by stepping through the presentation groups one at a time by selecting the next presentation group button 214 or the previous presentation group button 212. Of course, many other selection methods (e.g. hot keys) could be used. When a new presentation group is selected, step (110) is executed and the process of displaying the images (step (111)) and altering the user interface (step (112)) is repeated.

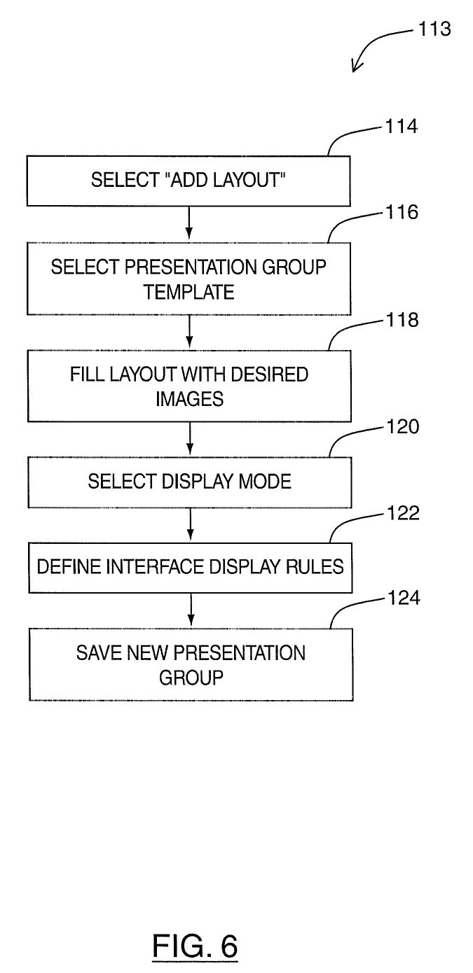

Reference is now made to FIG. 6 which is a flowchart diagram illustrating the operational steps 113 involved in defining a new presentation group.

As can be seen in FIG. 5, presentation group list 210 may include an “Add Layout” option which allows the user at step (114) to define a new presentation group for association with the current hanging protocol. When the “Add Layout” option is selected at step (114), user 11 is presented with a list of possible presentation group templates which determine the screen layout of the presentation group (e.g. two by two image stacks, one full screen image stack).

Referring back to FIG. 6, at step (116), the user 11 selects one of the presented templates. Each presentation group contains a collection of display sets which define the images from study(ies) 30 which will be displayed when the presentation group is applied.

At step (118), the user 11 fills the screen layout of the selected template with specific images by dragging and dropping an image series from the available image series tray which shows all loaded image series. These selections are used to define the display sets for the presentation group. At step (120), the user can change the display mode of one or more images (e.g. switch from two dimensional image to a three dimensional rendition of a stack of images).

At step (122), the user 11 defines the interface display rules for the presentation group. The interface display rules may be defined by selecting interface elements to be added to the user interface from a list of available interface elements and selecting interface elements to be removed from the user interface from a list of removable interface elements. The user 11 may first create any desired interface elements which are not part of the standard set of interface elements using a standard form designer type user interface. The next step is to select the interface elements to be added to the user interface.

Reference is now made to FIG. 8A which illustrates an exemplary interface used to select the interface elements to be added to the user interface. The interface element library textbox 802 displays the list of available interface elements, including standard interface elements and those interface elements which were created by user 11. The interface elements to add textbox 804 displays the list of interface elements which have been selected to be added to the user interface. In order to add an interface element to the user interface, the interface element is highlighted in the interface element library textbox 802 and included in the interface elements to add textbox 804 using include button 810, Similarly, an interface element in the interface elements to add textbox 804 may be highlighted and excluded from the list of interface elements to be added using exclude button 812.

Reference is now made to FIG. 8B which is a schematic diagram that illustrates an example user interface used by a user 11 to select the interface elements to be removed from the user interface. The interface element library textbox 806 displays the list of removable interface elements. The interface elements to remove textbox 808 displays the list of interface elements which have been selected to be removed from the user interface. In order to remove an interface element from the user interface, the interface element is highlighted in the interface element library textbox 806 and included in the interface elements to remove textbox 808 using include button 814, Similarly, an interface element in the interface elements to remove textbox 808 may be highlighted and excluded from the list of interface elements to be removed using exclude button 816.

Referring back to FIG. 6, the final stage of step (122) is positioning the interface elements selected to be added to the user interface within the diagnostic interface 23.

It should be understood that other ways of defining the interface display rules are possible. For example, a set of template user interfaces may be presented to the user 11 for selection.

The type of interface elements appropriate for a specific presentation group may depend on a number of factors such as the type of images displayed or the purpose of the study. For example, it does not make sense to display a cine controller (used to animate a series of images) if only a single image is referenced. If a cine controller were included in the default interface, it may be removed for presentation groups displaying single images in order to keep the interface as simple as possible. On the other hand, some orthopedic data sets might require special orthopedic measurement tools which could be added to a presentation group displaying this type of data.

In the present discussion, we have assumed that the interface elements which are added and removed from the user interface when a particular presentation group is selected depend only on the presentation group. However, it should be understood that the interface elements which are added and removed from the user interface when a particular presentation group is selected may also depend on other various factors including without limitation, the user 11, the workstation 19, the diagnostic interface 23 or other factors alone or in combination.

Once the presentation group template, images, display mode and interface display rules have been determined, the new presentation group is saved at step (124) and added to the presentation group list 210.

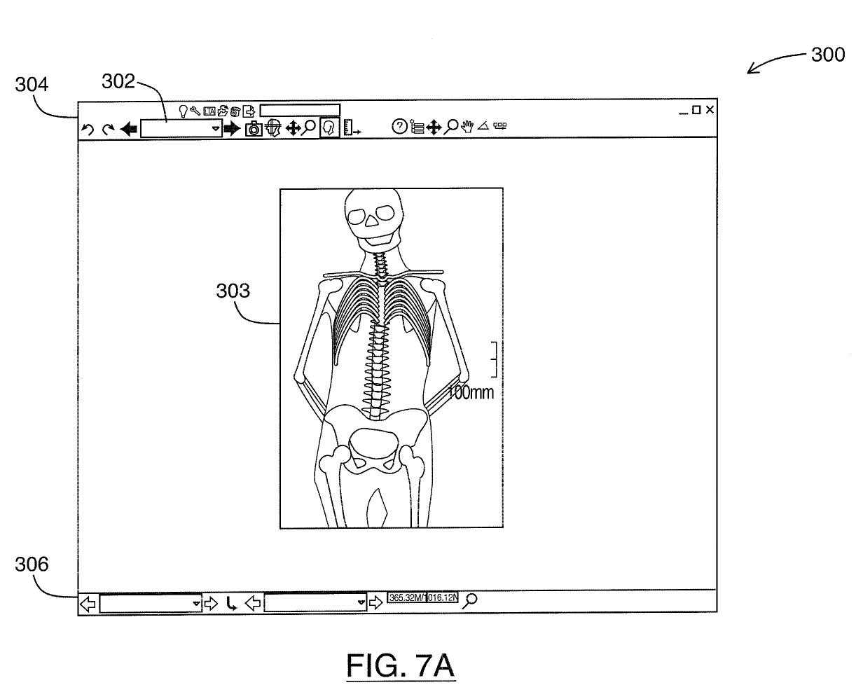

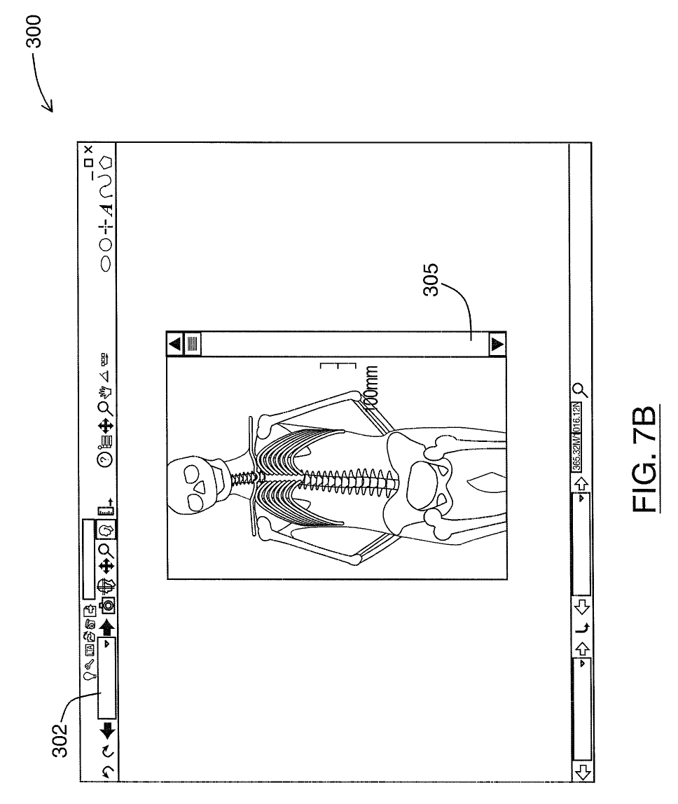

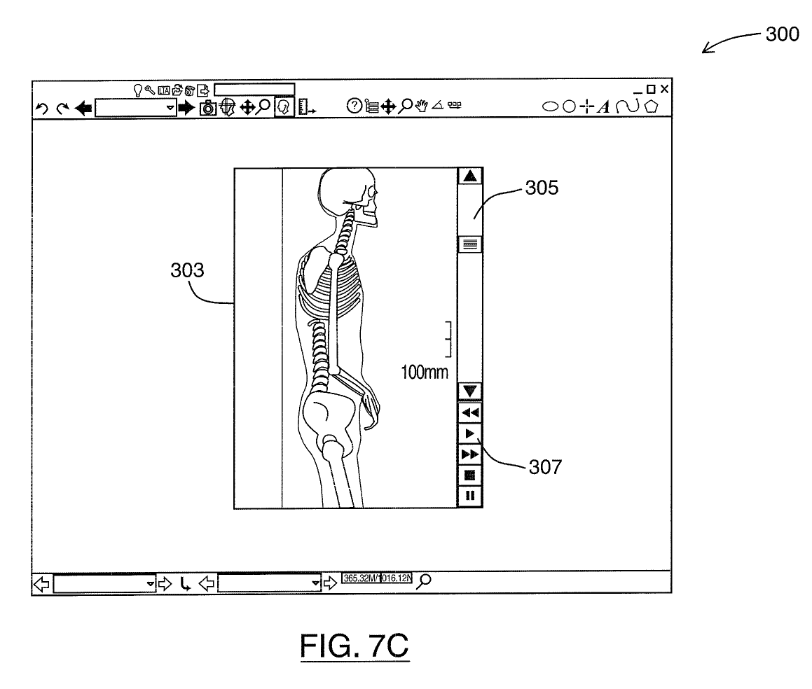

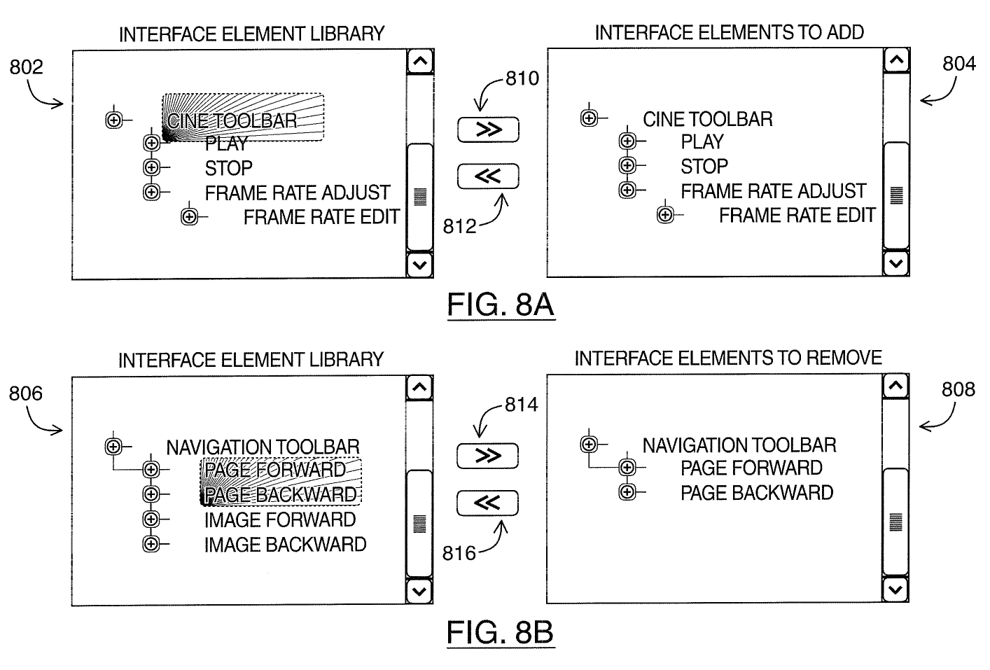

Reference is now made to FIGS. 7A, 7B and 7C which show examples of interface elements 305 and 307 that may be associated with a specific presentation group 218.

Specifically, FIG. 7A shows interface 300 with the default user interface. Top toolbar 304 and bottom toolbar 306 each contain the default interface elements which were defined when user 11 logged into workstation 19. The second presentation group 218, Axial with Localizer, has been selected but no interface elements have be added or removed from the default user interface. Display area 303 contains a series of images from an image study 30.

FIG. 7B shows the same series of images from image study 30 displayed with the same screen layout but with scrollbar 305 added to display area 303 in order to allow the user to scroll through the various images in the series of images displayed in display area 303.

FIG. 7C again shows an image study 30 displayed with the same screen layout but here display area 303 contains not only scrollbar 305 but also cine controls 307 which allow the user to animate the series of images. These interface elements will be displayed whenever this presentation group is selected. When the user navigates to a different presentation group, these elements may again disappear.

While the various exemplary embodiments of the image display system 10 have been described in the context of medical image management in order to provide an application-specific illustration, it should be understood that the image display system 10 could also be adapted to any other type of image or document display system.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method for displaying at least one image on a display interface according to a first presentation group of a hanging protocol, said method comprising:
(a) defining a first set of interface display rules for the first presentation group;
(b) evaluating the first set of interface display rules;
(c) displaying the at least one image according to the first presentation group;
(d) determining a first set of interface elements based on the application of the first set of interface display rules; and
(e) displaying the first set of interface elements in association with the display of the at least one image.

2. The method of claim 1, wherein defining a first set of interface display rules for the first presentation group comprises defining a list of interface elements to be added and a list of interface elements to be excluded.

3. The method of claim 2, wherein the method includes defining a default user interface.

4. The method of claim 3, wherein (e) includes adding and removing certain of the interface elements from the default user interface.

5. The method of claim 3, wherein the default user interface depends on the type of display interface.

6. The method of claim 3, wherein if a user is currently logged into the workstation, then the default user interface depends on the identity of the user.

7. The method of claim 1, wherein (a) is performed by a user.

8. The method of claim 1, wherein (a) is performed by a system designer.

9. The method of claim 1, wherein evaluating the interface display rules includes considering system characteristics.

10. The method of claim 1, wherein defining a first set of interface display rules for the first presentation group comprises selecting a template interface.

11. The method of claim 1, wherein defining a first set of interface display rules for the first presentation group comprises selecting the first set of interface elements from a list of available interface elements and positioning the first set of interface elements on the display interface.

12. The method of claim 1, wherein, after (e), the method further comprises:
(f) defining a second presentation group with a second set of interface display rules.

13. The method of claim 12, wherein, after (f), the method further comprises:
(g) evaluating the second set of interface display rules;
(h) displaying the at least one image according to the second presentation group; and
(i) displaying a second set of interface elements based on the second set of interface display rules.

14. The method of claim 1, wherein the first set of interface elements includes at least one of a scrollbar, a menu, a toolbar, an animation tool set, and a text panel.

15. A computer-readable medium upon which a plurality of instructions are stored, the instructions for performing the steps of the method as claimed in claim 1.

16. An image display system for displaying at least one image on a display interface according to a first presentation group of a hanging protocol, said system comprising:
(a) a memory for storing the at least one image, the first presentation group and the hanging protocol;
(b) a processor coupled to the memory configured for:
(I) defining a first set of interface display rules for the first presentation group;
(II) evaluating the first set of interface display rules;
(III) displaying the at least one image according to the first presentation group;
(IV) determining a first set of interface elements based on the application of the first set of interface display rules; and
(V) displaying the first set of interface elements in association with the display of the at least one image.

17. The system of claim 16, wherein defining a first set of interface display rules for the first presentation group comprises defining a list of interface elements to be added and a list of interface elements to be excluded.

18. The system of claim 17, wherein the processor is further adapted to define a default user interface.

19. The system of claim 18, wherein (V) includes adding and removing certain of the interface elements from the default user interface.

20. The system of claim 18, wherein the default user interface depends on the type of display interface.

21. The system of claim 18, wherein if a user is currently logged into the workstation, then the default user interface depends on the identity of the user.

22. The system of claim 16, wherein the first set of interface display rules are defined by a user.

23. The system of claim 16, wherein the first set interface display rules are defined by a system designer.

24. The system of claim 16, wherein evaluating the interface display rules includes considering system characteristics.

25. The system of claim 22, wherein the first set of interface display rules are defined by selecting a template interface.

26. The system of claim 22, wherein the first set of interface display rules are defined by selecting the first set of interface elements from a list of available interface elements and positioning the first set of interface elements on the display interface.

27. The system of claim 16, wherein, after (V), the processor is further adapted to:
(VI) define a second presentation group with a second set of interface display rules.

28. The system of claim 27, wherein, after (VI), the processor is further adapted to:
(VII) evaluate the second set of interface display rules;
(VIII) display the at least one image according to the second presentation group; and
(IIX) display a second set of interface elements based on the second set of interface display rules.

29. The system of claim 16, wherein the first set of interface elements includes at least one of a scrollbar, a menu, a toolbar, an animation tool set, and a text panel.
